(19) United States
(12) Patent Application Publication
(10) Pub. No.: US 2007/0242197 A1
(43) Pub. Date: Oct. 18, 2007

(54) Transflective LC Display Having Backlight With Spatial Color Separation

(75) Inventors: Philip E. Watson, St. Paul, MN (US); Andrew J. Ouderkirk, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/734,567

(22) Filed: Apr. 12, 2007

Related U.S. Application Data
(60) Provisional application No. 60/744,725, filed on Apr. 12, 2006.

(51) Int. Cl. G02F 1/1335

(52) U.S. Cl. 349/114

(57) ABSTRACT

A transflective display includes a liquid crystal (LC) panel having an array of pixels defining a viewing area, the panel being disposed between a front and back polarizer. The display also includes a backlight and a transflector, except that the transflector may optionally be or include the back polarizer. The transflector is disposed between the LC panel and the backlight. The backlight produces multiple light components that are separated spatially over the viewing area to give the display a full color appearance in the transmissive viewing mode. The multiple light components may be, for example, red, green, and blue light components, or another set of light components capable of producing white light. The display can provide a monochrome image in reflection and a full color image in transmission.

### CROSS REFERENCE TO RELATED APPLICATIONS

This application claims the benefit under 35 U.S.C. § 119(e) of U.S. Provisional Application 60/744,725, filed Apr. 12, 2006.

### FIELD OF THE INVENTION

The present invention relates to display devices, particularly those that utilize a liquid crystal (LC) panel and that can operate in both reflected ambient light and transmitted light originating from a backlight, and related articles and processes.

### DISCUSSION

Microprocessor-based devices that include electronic displays for conveying information to a viewer have become nearly ubiquitous. Mobile phones, handheld computers, personal digital assistants (PDAs), electronic games, MP3 players and other portable music players, car stereos and indicators, public displays, automated teller machines, in-store kiosks, home appliances, computer monitors, and televisions are examples of such devices. Many of the displays provided on such devices are liquid crystal displays (LCDs or LC displays).

Unlike cathode ray tube (CRT) displays, LCDs do not have a phosphorescent image screen that emits light and, thus, require a separate light source for viewing images formed on such displays. For example, a source of light can be located behind the display, which is generally known as a “backlight.” The backlight is situated on the opposite side of the LCD from the viewer, such that light generated by the backlight passes through the LCD to reach the viewer. An LC display using such a backlight can be said to be operating in “transmissive” mode. An alternative source of illumination can be from an external light source, such as ambient room lights or the sun.

Some LC displays are designed to operate in either of two modes: the transmissive mode utilizing a backlight, described above, or a “reflective” mode, utilizing light reflected from an external light source situated on the viewer-side of the LCD. Such LC displays, known as “transflective” displays, commonly possess an LC panel and a partially reflective layer between the LC panel and the backlight. In other cases, the partially reflective layer is disposed inside the LC panel rather than between the LC panel and the backlight. In either case, the partially reflective layer, referred to herein as a “transflector”, transmits a sufficient portion of light from the backlight, while also reflecting a sufficient portion of external light, to permit the display to be viewed in both transmissive mode and reflective mode. An exemplary transflector is Vikuiti™ Transflective Display Film (“TDF”) available from 3M Company. This film includes a reflective polarizer, i.e., a body that reflects light of one polarization state and transmits light of an orthogonal polarization state, formed from a polymeric multilayer optical film. The TDF product also includes a layer of diffuse adhesive.

The LC panel component of the LC display commonly includes two substrates and a liquid crystal material disposed between them. The substrates may be fabricated from glass, plastic, or other suitable transparent materials. The substrates are supplied with an array of electrodes that can provide electrical signals to a corresponding array of individual areas known as picture elements (pixels), which collectively define the viewing area of the display and individually define the resolution of the display. Electrical signals provided by the electrodes, typically in conjunction with thin film transistors (TFTs), permit the optics of each pixel to be adjusted, for example to either significantly modify the polarization state of transmitted light, or to allow the light to pass without significant modification to its polarization state. In some cases the electrical signal can switch the liquid crystal from a transmissive state to a scattering state, or provide some other optical change in the pixel. The LC panel typically does not include a highly absorptive color filter situated between the substrates. It may, however, include a weak color filter that absorbs less than 50% of incident light over the visible spectrum.

The liquid crystal material in the LC panel may be nematic, as in the case of a Twisted Nematic (TN), Optically Compensated Bend (OCB), Supertwisted Nematic (STN), or bistable nematic liquid crystal, or other known nematic modes. It may also be a smectic liquid crystal as used in Ferroelectric, Antiferroelectric, Ferrielectric, and other smectic modes. The liquid crystal may also be a cholesteric liquid crystal, a liquid crystal/polymer composite, a polymer-dispersed liquid crystal, or any other type of liquid crystal configuration that may be electrically switched between at least two optically differentiable states.

Usually, LC displays are either monochrome or color. In a monochrome display, each of the pixels in the viewing area can be made to be dark, bright, or an intermediate intensity level, as in a grayscale image. Such intensity modulation is usually used with white light (to yield pixels that are white, black, or gray) but can alternatively be used with light of any other single color such as green, orange, etc. But such intensity modulation cannot produce a range of colors at any arbitrary location on the viewing area. In contrast, “full color” LC displays can produce a range of perceived colors, such as red, green, or blue, at any arbitrary location within the viewing area.

One technique for obtaining full color performance from an LCD is to provide an absorbing (patterned) color filter between the transparent substrates of the LC panel. In such a case, each pixel is subdivided into three or more regions or subpixels, each of which is individually controllable and associated with a particular color of the absorbing color filter, such as the primary colors of red, green, and blue, or other color combinations capable of producing substantially white light. If such a color filter is used in the LC panel of a transflective display, the high average absorption of the color filter substantially reduces the available brightness of both the transmissive and reflective operating modes, limiting the display's ability to present easily viewable images.

The design of traditional transflective systems often involves compromises between reflective brightness, transmissive brightness, and color generation. Typically, a transflective layer, located either between the transparent substrates of the liquid crystal panel, or between the liquid crystal panel and the backlight, will reflect a fraction of incident light in order to provide illumination from external sources in the reflective mode, and will transmit a different fraction of incident light in order to provide illumination from the backlight in the transmissive mode. The design of the transflector may be tuned such that the transmissive mode or reflective mode is brighter, often at the expense of the other.

### BRIEF SUMMARY

The present application discloses, inter alia, a transflective display having a reflective viewing mode and a transmissive viewing mode. The display includes a liquid crystal (LC) panel having an array of pixels defining a viewing area, the panel being disposed between a front and back polarizer. The display also includes a backlight and a transflector, except that the transflector may optionally be or include the back polarizer. The transflector is disposed between the LC panel and the backlight. The backlight produces multiple light components that are separated spatially over the viewing area to give the display a full color appearance in the transmissive viewing mode. The multiple light components may be, for example, red, green, and blue light components, or another set of light components capable of producing white light.

In some embodiments, the backlight includes a broadband light source and a layer that separates light from the light source into the multiple light components by diffraction.

In some embodiments, the backlight includes a broadband light source and a layer that separates light from the light source into the multiple light components by dispersion, i.e., refraction of different wavelengths of light at different angles as the result of a material whose refractive index changes substantially with wavelength.

In some embodiments, the backlight includes a broadband light source and a layer that separates light from the light source into the multiple light components by a patterned filter, the pattern having areas corresponding to the pixels and selectively transmitting a designated one of the multiple light components. In some cases the patterned filter selectively absorbs light components other than the designated light component in a given patterned area. In other cases the patterned filter selectively reflects light components other than the designated light component in the given patterned area.

Due to the placement of the color filter in relation to the transflector, disclosed LC displays are capable of monochrome operation in reflective mode and full color operation in transmissive mode. The same pixels can be used for both modes for enhanced efficiency, also enabling higher resolution operation in the reflective mode compared to the transmissive mode.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a schematic side view of a portion of a transflective liquid crystal display having a backlight with spatial color separation;

FIG. 2 is a schematic plan view of a portion of a patterned filter; and

FIG. 3 is a schematic side view of a portion of another transflective liquid crystal display having a backlight with spatial color separation.

In the figures, like reference numerals designate like elements.

### DETAILED DESCRIPTION OF ILLUSTRATIVE EMBODIMENTS

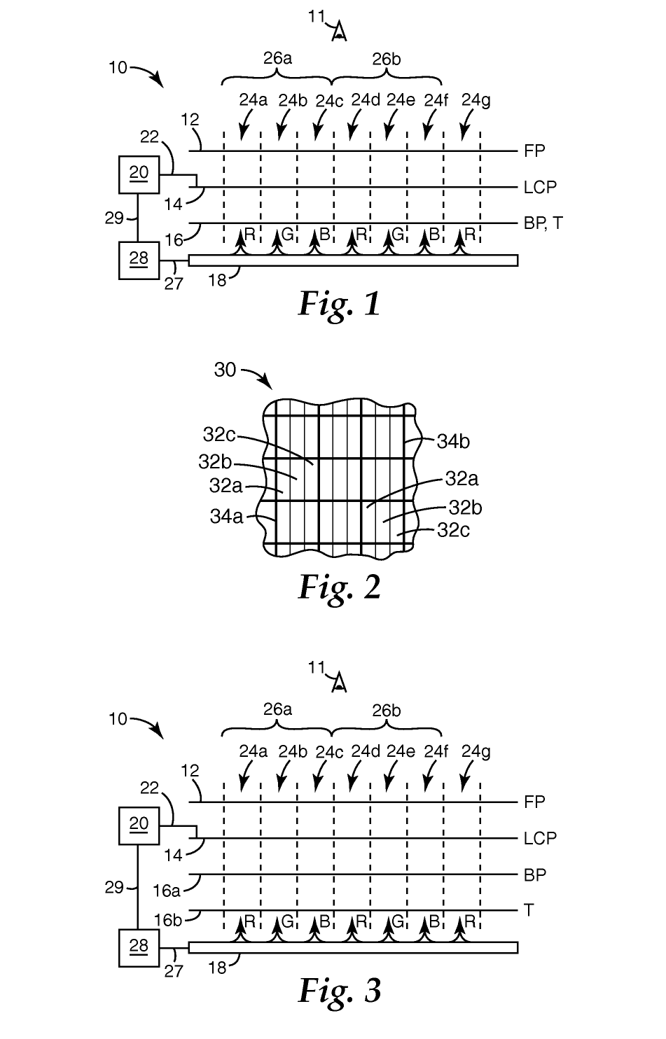

FIG. 1 shows a schematic side view of a portion of a transflective LC display 10 that includes a front polarizer 12, an LC panel 14, a back polarizer 16, and a backlight 18. A controller 20 is electronically coupled to LC panel 14 via a connection 22 to control the optical state of individual pixels 24a-g of the LC panel, which pixels extend in a repeating pattern or array over an area that defines the overall viewing area of the display.

Front polarizer 12 can be any known polarizer, but in exemplary embodiments it is an absorptive polarizer (sometimes also referred to as a dichroic polarizer) for ease of viewing and reduced glare for observer 11. Preferably, polarizer 12 is a flexible polymer-based film and is laminated or otherwise adhered to LC panel 14, for example, using an optically clear adhesive. If polarizer 12 is a linear polarizer, it has a pass axis and a block axis in the plane of the film or layer. Light polarized parallel to the pass axis is transmitted, and light polarized parallel to the block axis (perpendicular to the pass axis) is blocked e.g. by absorption, by the front polarizer 12.

LC panel 14 includes a liquid crystal material sealed between two transparent substrates and an array of electrodes that define a corresponding array of pixels 24a-g. A controller 20 is capable of addressing or controlling each of the pixels individually so as to form a desired image. Depending on whether a given pixel is turned on or off, or at an intermediate state, the LC panel rotates the polarization of light passing therethrough by about 90 degrees, or by about zero degrees, or by an intermediate amount. The LC panel may have its front face attached to the front polarizer, and may also include a diffuser film, an antireflection film, an anti-glare surface, or other front-surface treatments.

Back polarizer 16 is a reflective polarizer, preferably but not necessarily of polymeric multilayer design as described in U.S. Pat. No. 5,882,774 (Jonza et al.), or U.S. Application Publication Nos. 2002/0190406 (Merrill et al.), 2002/0180107 (Jackson et al.), 2004/0099992 (Merrill et al.) and 2004/0099993 (Jackson et al.). As such, the polarizer 16 has a pass axis and a block axis in the plane of the polarizer, where light polarized parallel to the pass axis is substantially transmitted and light polarized parallel to the block axis is substantially reflected by the polarizer 16. Absorption in the polarizer 16 is typically negligible, particularly over visible wavelengths. The pass axis of the back polarizer 16 can have any desired orientation with respect to the pass axis of front polarizer 12, but for purposes of the present description we will assume it is perpendicular thereto. In such case, display 10 is an inverting-type transflector, because pixels 24 whose state (determined by controller 20) makes them bright in reflective viewing mode makes them dark in transmissive viewing mode, and pixels 24 whose state makes them dark in reflective viewing mode makes them bright in transmissive viewing mode. (Discussed below in connection with FIG. 3 is a non-inverting display, where pixels whose state makes them bright in reflective viewing mode makes them bright in transmissive viewing mode, and pixels whose state makes them dark in reflective viewing mode also makes them dark in transmissive viewing mode.)

In this regard, transflective displays generally fall under two classes of operation: inverting and non-inverting. Non-inverting displays provide the same image in both the reflective and transmissive operating modes, because in both cases, any light that exits the display travels from the transflector to the back polarizer (which defines the light's polarization state), through the LC panel, and exits through the front polarizer. External light incident on the display passes through the front polarizer, through the LC panel, through the back polarizer, reflects from the transflector, passes back through the back polarizer and the LC panel, and exits through the front polarizer. Light from the backlight passes through the transflector, through the back polarizer, through the LC panel, and exits through the front polarizer. Since the two operating modes provide similar images (although the reflective-mode image will be monochrome while the backlit image may be colored), then the light exiting the system from the reflective and transmissive modes will work together to provide a brighter overall image. Typically, in cases where the transflector does not also act as the display back polarizer, the display is non-inverting. But some non-inverting displays can include a reflective polarizer as the transflector.

Inverting displays commonly utilize a reflective polarizer for the transflector, and that reflective polarizer is also the back polarizer of the LC display. The transflector may, for example, be a sheet of Vikuiti™ RDF-C film (3M Company, St. Paul, Minn.) laminated in place of a conventional absorptive back polarizer in the display. The RDF-C film includes a polymeric multilayer reflective polarizer and a layer of light-diffusing adhesive. In this case, external light incident on the display passes through the front polarizer, then through the LC panel, and impinges on the transflector. At this point, one polarization state (state “1”) is reflected, and passes back through the LC panel and the front polarizer. But light of an orthogonal polarization state (state “2”) is transmitted by the transflector and is absorbed or otherwise lost in the vicinity of the backlight. For light originating from the backlight, polarization state 2 is transmitted through the transflector, through the LC panel, and through the front polarizer, while polarization state 1 is reflected back into the backlight and lost. Thus, the reflective operating mode introduces polarization state 1 into the LC panel, while the transmissive operating mode introduces polarization state 2 into the LC panel, and the two images will therefore be reversed. Consequently, the transmissive mode image appears as a photo-negative of the reflective mode image, except that the transmissive mode image may contain bright colors, while the reflective mode image may be monochrome.

In the case of inverting displays, it is also possible to modify the image output electronically using controller 20 in order to correct for the optical inversion. Controller 20 may for example include an electronic inversion algorithm that is activated or not depending upon whether the backlight 18 is energized, i.e., depending on whether the display 10 is in reflective mode or transmissive mode. Such an algorithm can electronically modify the control signals to the individual pixels to electronically invert the image in the transmissive mode when the backlight is activated, so that the image appears with the same foreground/background scheme as in the reflective mode.

In LC display 10, the back polarizer 16 also serves as the transflector. If desired, a polarization-preserving light diffusing layer can also be included as part of the transflector to enhance the appearance of the image. The transflector 16 is situated between the LC panel 14 and the backlight 18 such that it can reflect light from external sources such as room lights or the sun.

The transflector may include any multilayer optical film having a polarizing function, including the line of Vikuiti™ DBEF products, Vikuiti™ TDF film, Vikuiti™ RDF-C film, and the polarizers described in the '774 Jonza et al. patent above. The transflector may also include a second reflective polarizer aligned with its pass axis rotated with respect to the pass axis of the first reflective polarizer. In a related configuration, the transflector may also be or include a reflective cholesteric liquid crystal polymer layer that transmits one circular polarization state of light and reflects another. Such a transflector may also include a wave plate, such as a ¼ wave retarder, to modify the polarization state of light from circular to linear and vice versa. The transflector may also have a reflection and/or transmission spectrum that varies over the visible spectrum.

The transflector can be affixed to the LC display (or to a separate back polarizer, if one exists distinct from the transflector) using a diffusing adhesive, a clear adhesive, or other means, or may be free-floating, or affixed to the backlight 18. It may include additional layers and coatings such as laminated plastic or glass films that provide durability, rigidity, environmental robustness, or EMI shielding, or that may provide other optical effects such as diffusion, anti-reflection, or anti-glare properties.

Backlight 18 produces multiple light components that are separated spatially over the viewing area to give the display a full color appearance in the transmissive viewing mode. In other words, backlight 18 emits substantially white light, but it emits the light in a set of light components (colored beams) that are spatially separated in an array that matches the pixel array, the two arrays being aligned with each other. This is shown in FIG. 1 by the beams labeled R, G, B emitted by backlight 18 in a spatial arrangement that coincides with the pixels 24a-g. Although the R, G, B labels may refer to red, green, and blue, other additive color schemes are also contemplated, including schemes having more than three colors. In some cases it is desirable for the spatially separated beams to be partially collimated, or at least to be more collimated than a Lambertian emitter. Such collimation can reduce color mixing between adjacent pixels, and can also be helpful when the LC display includes multilayer optical films or other interference reflectors having reflection and transmission properties that can shift as a function of incidence angle.

Adequate alignment between the spatially separated light components of the backlight and the pixel array of the LC panel is difficult to maintain for arbitrarily high or oblique viewing angles, due to the finite physical thickness of the layers involved and the phenomenon of parallax. These limitations of parallax can be reduced by keeping the thickness of the individual layers as small as possible. For example, the transparent substrates of the LC panel, between which the liquid crystal material is sealed, each preferably consists of very thin display glass, e.g., no more than 0.4 mm, or 0.2 mm, or 0.1 mm thick. Keeping the output of the backlight relatively well collimated can also help in this regard.

A variety of backlight constructions are capable of producing the spatially separated light components. We will describe briefly several approaches, without wishing to be limited thereby: separation by diffraction (diffractive color separation, DCS), separation by dispersion (refractive color separation, RCS), and separation by a patterned absorptive or reflective filter (backlight color filtering, BCF). These backlight-based color separation techniques can allow the LC display to operate in a low-power monochrome or weakly colored reflective mode having little or no absorptive losses, but also provide full-color images in the transmissive mode as needed. This is because there is preferably substantially no pixilated color filter (but there may be a weak color filter) within the LC panel or anywhere in the light path on the viewer side of the transflector.

Conventionally, an LC display backlight provides white light to the LC panel, and the LC panel includes a patterned color filter printed in registration with the pixels to separate the light into a colored image. The backlight generates light using electrically driven lamps, such as Cold Cathode Fluorescent Lamps (CCFLs), Hot Cathode Fluorescent Lamps (HCFLs), Flat Fluorescent Lamps (FFLs), Electroluminescent lights (EL), Organic Light Emitting Diodes (OLEDs), Plasma Backlight Panels (PBP), Light Emitting Diodes (LEDs), or similar devices. More exotic light sources, such as lasers, halogen lights, arc-lamps, X-ray phosphorescence, incandescence, or controlled flames, may also be used.

Backlight 18 can use any of the above-mentioned light sources, provided they are configured or combined with lenses, light enhancement films, light guides, or other components such that the light illuminates the entire viewing area of the display but is also spectrally and spatially divided to form an array of spectrally distinguishable light components over that viewing area. An exemplary array is a rectangular grid of alternating red, green, and blue light components, but other repeating patterns are also contemplated, such as RGBG, and so forth. The spatial separation can be achieved straightforwardly with a patterned absorptive or reflective (e.g. multilayer or other interference) filter, referred to above as the BCF technique. Spatial separation can also utilize components that angularly separate different wavelengths of light, as with the DCS and RCS techniques. These latter techniques may require a relatively high degree of collimation of light at the input of the diffractive or dispersive component, so that the angular separation can adequately isolate the different light components spatially.

The DCS technique can use a white light source, either through use of white LEDs (e.g. containing a UV- or blue-emitting LED die that excites a yellow-emitting phosphor), colored LEDs activated simultaneously, or CCFL bulbs. However, any of the white light source types described above may be used.

The DCS technique also preferably includes a collimating system, a grating system, and a lens system. The collimating system, typically a wedge-shaped light guide coupled with a prismatic turning film, or of any type of backlight with prismatic Brightness Enhancement Film such as 3M's BEF, takes input light and projects it toward the grating system with a narrow light cone, of FWHM of 40° or less in at least one dimension, and preferably of FWHM of 20° or less. The grating system, commonly in the form of an optical blazed phase grating, separates the light angularly into color bands. The lens system, typically a 1-dimensional (single row of long, narrow elements) or 2-dimensional (rows and columns of elements) microlens array, takes light from the grating system, and focuses it onto an image plane in the form of color-separated lines, dots, or other defined regions, thus producing spatially separated multiple light components. In some cases, the lens system may be replaced by a diffusion system located at a controlled distance from the grating system so as to forward-scatter incident light, providing a multi-colored light plane for illuminating the display.

The lens system and grating system may be combined into a single element, where the grating and lens are on the same side or opposite sides of a monolithic or few-layer film. Alternatively, they may be formed as separate elements, or be combined with other elements in the display system. For example, the grating may be disposed on one face of a wedge-shaped light guide, while a lens film may be combined into a single film with the transflector, such as through lamination or direct microreplication using a metal tool and a photocurable polymer onto the transflector surface, or they may be combined by other means.

Representative DCS-related backlights, light sources, or components thereof suitable for use in backlight 18 of transflective LC display 10 include those described in U.S. Pat. Nos. 5,497,269 (Gal), 5,600,486 (Gal et al.), 5,889,567 (Swanson et al.), 6,618,106 (Gunn et al.), and U.S. Patent Publications US 2005/0041174 (Numata et al.) and US 2005/0078374 (Taira et al.).

A backlight employing an RCS-related technique separates light by the same optical principle at work when projecting a rainbow from a sunlit equilateral triangular parallelepiped glass prism. That is, the refractive index of the material changes monotonically over the wavelength range of interest, and the angle of refraction of obliquely incident light therefore also changes as a function of the wavelength or color of the light. The RCS-based backlight typically includes a prism system and a lens system. Each of these systems may be or include a microreplicated or otherwise molded sheet or film. For maximum color separation, at least the prism system is preferably composed of a material having a large monotonic dispersion over the visible spectrum, e.g., a liquid crystal polymer. Reference is also made to U.S. Pat. No. 4,686,519 (Yoshida et al.) for RCS-related components suitable for use in backlight 18.

Backlight 18 may also employ the BCF technique, in which an otherwise conventional white extended backlight illuminates a patterned filter. The filter has areas or cells corresponding to the LC panel pixels, and selectively transmit a designated one of the multiple light components. FIG. 2 depicts schematically representative filter areas or cells of such a patterned filter. In FIG. 2, pattern 30 has rectangular areas or cells 32a, 32b, 32c that repeat along columns and rows of a rectangular array sized to mate with a corresponding rectangular array of LC panel pixels. Cells 32a,b,c may transmit red, green, and blue light respectively, or other sets of usually three or more distinguishable colors capable of producing white light as desired.

Note that groups of neighboring cells form larger cells 34a, 34b, which substantially represent the resolution of the display when it is operating in the full-color transmissive viewing mode. Interestingly, finer resolution is achievable in monochrome reflective viewing mode, because pixels of the LC panel corresponding to the smaller cells 32a can then be used as the smallest addressable element of the image. This difference in resolution is also depicted in FIG. 1, where pixels 24a-c can function as different colored sub-pixels of a larger pixel 26a, and pixels 24d-f can function as different colored sub-pixels of a larger pixel 26b, and so forth.

An actual difference in resolution from one viewing mode to the other can only be achieved if the controller 20 activating the pixels 24 is programmed accordingly. Thus, in reflective viewing mode with backlight 18 turned off, controller 20 processes the image in high resolution monochrome, driving each individual pixel 24 independently to form the high resolution image. In transmissive viewing mode, with backlight 18 turned on, controller 20 processes the image in a lower resolution color format, where the larger combination pixels 26a, 26b, etc. define the smallest spatial resolution and their constituent sub-pixels (24a,b,c for example) are driven with a predetermined relationship in order to produce the correct resultant color for the larger pixel (26a, for example). Preferably, the controller 20 switches automatically between the high resolution monochrome control mode and the lower resolution color control mode according to the status of the backlight. Thus, if the user activates a switch, or if a sensor is included to detect the ambient light level, and the light level falls below a predetermined value, then a backlight controller 28 energizes the backlight 18 over connection 27 to turn the backlight on or to keep it on, and controller 20 detects this status of the backlight over connection 29. In response, LC panel controller 20 processes the image using the low resolution color control mode, and drives the pixels of the LC panel 14 via connection 22 accordingly. If the user then activates another switch or the ambient light level rises above another predetermined value, backlight controller 28 can shut the backlight 18 off, and in response to the status change conveyed over connection 29 the controller 20 can then process the image using the higher resolution monochrome control mode and drive the LC panel pixels accordingly.

In cases where the backlight 18 uses multiple distinct lamps or light sources to provide the multiple light components required for full color operation, it may be advantageous for power savings or for other reasons to allow the backlight controller 28 to energize less than all or even only one of such lamps or light sources, even if full color operation is then sacrificed.

Returning again to FIG. 2, filter pattern 30 can be implemented in a variety of films, coatings, or substrates. For example, conventional colored pigments that selectively transmit red, green, and blue light, but absorb other wavelengths, can be printed on a transparent film or substrate.

Alternatively, an interference film such as a multilayer optical film having high reflectivity over the visible spectrum except in a narrow wavelength band can be used. Such films are described in the '774 Jonza et al. patent referenced above, and in U.S. Pat. No. 6,157,490 (Wheatley et al.). Preferably, such a film is initially made (e.g. by coextrusion of tens, hundreds, or thousands of extremely thin alternating polymer layers and subsequent stretching of the film in one or two orthogonal directions) with a narrow transmission band at the longest visible wavelength desired, such as a red wavelength band corresponding to that desired for cells 32a. This multilayer film, which is initially substantially uniform over its entire area, is then embossed in a series of rectangular areas corresponding to cells 32b. The embossing is adjusted to thin the layers of the multilayer film in the cells 32b to shift the transmission band from the initial long wavelength to a shorter wavelength, such as from red wavelengths (e.g. about 650 nm) to green wavelengths (e.g. about 550 nm). Thereafter, another embossing step is carried out on cells 32c, where the embossing is adjusted to thin the layers at those locations to shift the transmission band to even shorter wavelengths, such as from red wavelengths (e.g. about 650 nm) to blue wavelengths (e.g. about 450 nm). In alternative approaches, the embossing steps can be performed simultaneously with a suitably shaped embossing tool or drum. Also, the initial long wavelength transmission band may be positioned at a slightly longer wavelength than the longest wavelength band desired for the filter. For example, the initial long wavelength transmission band may be positioned in the near infrared region. Then, all areas or cells making up the filter pattern may be selectively embossed to a degree sufficient to move the transmission band to the desired filter band for each of the respective areas or cells of the pattern. The embossing of the different areas can be done in separate embossing steps or a single step. In any event, the result of such an embossing procedure is an interference filter that transmits light of selected wavelengths in the respective areas or cells making up the pattern, and reflects other light. Such a filter can, similarly to the patterned absorptive filter, be laminated to other components or otherwise included in the backlight 18 to provide the spatially separated multiple light components.

FIG. 3 shows a portion of an LC display 40 similar to display 10 of FIG. 1, but where the combined back polarizer/transflector 16 is replaced by a separate back polarizer 16a and transflector 16b. Back polarizer 16a may be an absorptive polarizer, or any other polarizer having insufficient reflectivity to support the reflective viewing mode of the display. Transflector 16b can be or comprise a non-polarizing partially reflective layer, such as a light diffusing layer, or it can be or comprise a reflective polarizer whose pass axis is not aligned with the pass axis of back polarizer 16a, or it can comprise both such features. Exemplary embodiments of transflector 16b include the same components useable with transflector 16 of FIG. 1, including Vikuiti™ RDF-C film, Vikuiti™ TDF film, Vikuiti™ DBEF series of reflective polarizers, cholesteric-based reflective polarizers, and wire grid polarizers including those available from Moxtek Inc.

Because LC display 40 includes an absorptive back polarizer 16a in front of the transflector, it is a non-inverting display. Pixels that are bright in reflective viewing mode are also bright in transmissive viewing mode, and pixels that are dark in reflective viewing mode are also dark in transmissive viewing mode. Therefore, controller 20 need not include software to electronically invert the pixels of the LC panel 14, and the ambient light and backlit lighting are additive in increasing display brightness.

As the disclosed LC displays

Unless otherwise indicated, all numbers expressing quantities, measurement of properties and so forth used in the specification and claims are to be understood as being modified in all instances by the term “about.” Accordingly, unless indicated to the contrary, the numerical parameters set forth in the specification and claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The foregoing description is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention. All patents and patent applications referred to herein are incorporated by reference in their entireties, except to the extent they are contradictory to the foregoing specification.

1. A transflective display having a reflective viewing mode and a transmissive viewing mode, the display comprising:
a liquid crystal (LC) panel having an array of pixels defining a viewing area;
a front and back polarizer disposed on opposed sides of the LC panel;
a backlight;
a transflector, which may optionally be or include the back polarizer, disposed between the LC panel and the backlight;
wherein the backlight produces multiple light components that are separated spatially over the viewing area to give the display a full color appearance in the transmissive viewing mode.

2. The display of claim 1, wherein the transflector includes the back polarizer, and the back polarizer is a reflective polarizer.

3. The display of claim 1, wherein the array of pixels comprises multiple distinct groups of pixels corresponding to the multiple light components, each distinct group of pixels being illuminated, in the transmissive viewing mode, with its respective light component.

4. The display of claim 3, wherein the multiple light components are substantially red, green, and blue.

5. The display of claim 3, wherein the array of pixels consists essentially of the multiple distinct groups of pixels, and the multiple groups of pixels are also used to produce a monochrome image in the reflective viewing mode.

6. The display of claim 1, wherein the front and back polarizers are absorptive polarizers, and wherein the transflector includes a reflective polarizer and a light diffusing layer.

7. The display of claim 1, wherein the backlight includes:
a broadband light source; and
a layer that separates light from the light source into the multiple light components by diffraction.

8. The display of claim 1, wherein the backlight includes:
a broadband light source; and
a layer that separates light from the light source into the multiple light components by dispersion.

9. The display of claim 1, wherein the backlight includes:
a broadband light source; and
a layer that separates light from the light source into the multiple light components by a patterned filter, the pattern having areas corresponding to the pixels that selectively transmit a designated one of the multiple light components.

10. The display of claim 9, wherein the patterned filter selectively absorbs light components other than the designated light component in a given patterned area.

11. The display of claim 9, wherein the patterned filter selectively reflects light components other than the designated light component in the given patterned area.

12. The display of claim 11, wherein the patterned filter comprises an embossed interference film.
